(19) United States
(12) Patent Application Publication
(10) Pub. No.: US 2013/0047771 A1
(43) Pub. Date: Feb. 28, 2013

(54) ROBOT WITH CABLE PROTECTION STRUCTURE

(71) Applicants: JUN LIU, Shenzhen City (CN); CHUN-MING ZHANG, Shenzhen City (CN)

(72) Inventors: JUN LIU, Shenzhen City (CN); CHUN-MING ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/304,686

(22) Filed: Nov. 28, 2011

(30) Foreign Application Priority Data
Aug. 25, 2011 (CN) 201110245669.3

(51) Int. Cl. B25J 18/00

(52) U.S. Cl. 74/490.02; 74/490.03; 901/23; 901/25; 901/21

(57) ABSTRACT

A robot includes a first shaft housing, a second shaft housing rotatably assembled to the first shaft housing, a driver, a cable assembly, a transmission mechanism and a cable pass-through assembly. The driver is assembled within the first shaft housing for driving the second shaft housing to rotate relative to the first shaft housing. The cable pass-through assembly is assembled within the second shaft housing and defines a cable passage hole coaxial with the second shaft housing. The cable assembly passes through the cable passage hole of the cable pass-through assembly and electronically connects with the driver. The transmission mechanism is sleeved on the cable pass-through assembly for transmitting the driving force generated by the driver to the second shaft housing, thereby driving the second shaft housing to rotate relative to the first shaft housing.

### BACKGROUND

1. Technical Field

The present disclosure generally relates to robots, and particularly to a robot with cable protection structure.

2. Description of Related Art

As developments in manufacturing technology progress, robots are increasingly applied to perform functions in environments considered hazardous or difficult for human operators.

Cables are provided to transmit electric signals or control signals for the specific elements or components of the robot; and in order to maintain an orderly appearance, the cables are housed inside the robot and passed through a plurality of arms of the robot. When running from one arm to another, the cables pass through a plurality of holes in the arms. However, action of the arms may abrade or even sever the cables adjacent to the joint.

Therefore, there is room for improvement within the art.

### BRIEF DESCRIPTION OF THE DRAWINGS

The components in the drawings are not necessarily drawn to scale, the emphasis being placed upon clearly illustrating the principles of the present disclosure. Moreover, in the drawings, like reference numerals designate corresponding parts throughout several views, and all the views are schematic.

FIG. 1 shows an assembled isometric view of one embodiment of a robot.

FIG. 2 shows a partial assembled isometric view of the robot of FIG. 1.

FIG. 3 is a cross-section of the robot of FIG. 2 taken along a line labeled as III-III.

FIG. 4 shows a partial isometric view of the robot of FIG. 2.

### DETAILED DESCRIPTION

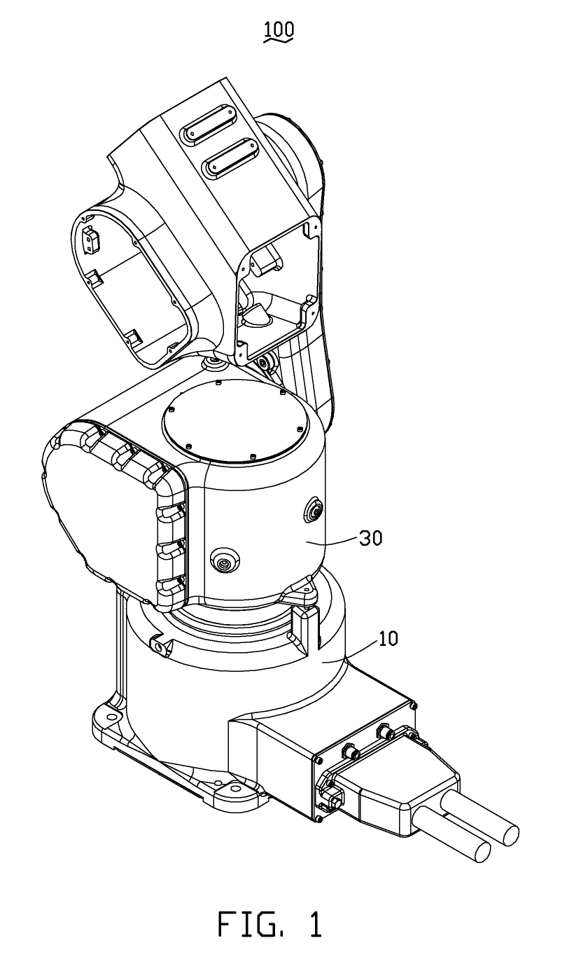

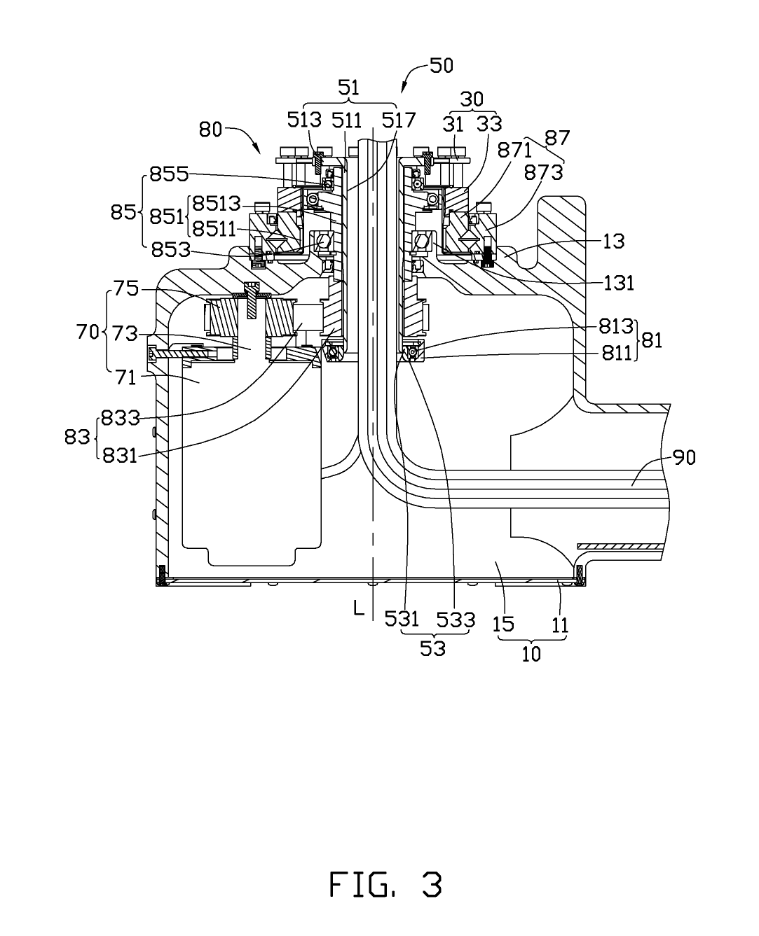

Referring to FIG. 1 and FIG. 3, an embodiment of a robot 100 includes a first shaft housing 10, a second shaft housing 30, a cable pass-through assembly 50, a driver 70, a transmission mechanism 80 and a cable assembly 90. The first shaft housing 10 and the second shaft housing 30 are both hollow shaped and rotatably assembled together via the transmission mechanism 80. The cable pass-through assembly 50 is fixedly assembled within the second shaft housing 30. The driver 70 is assembled within the first shaft housing 10 for driving the second shaft housing 30 to rotate relative to the first shaft housing 10. The transmission mechanism 80 is sleeved on the cable pass-through assembly 50 and is connected with the driver 70, for transmitting a driving force generated by the driver 70 to the second shaft housing 30, thereby driving the second shaft housing 30 to rotate relative to the first shaft housing 10. The cable assembly 90 passes through the cable pass-through assembly 50 for electrically connecting with the driver 70 and other components (not shown) and/or an external electric power source. In the illustrated embodiment, the cable assembly 90 includes a plurality of cables, in which one cable is connected to the driver 70. The robot 100 is a multi-axis robot.

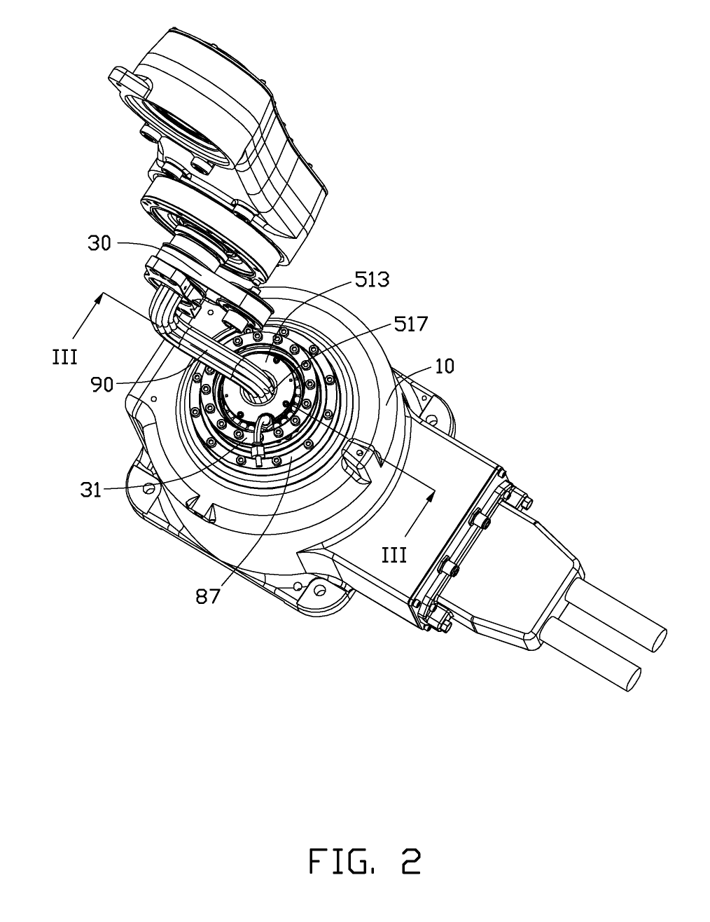

Also referring to FIG. 2, the first shaft housing 10 is substantially a hollow column formed by casting, and includes a first fixing end 11, a second fixing end 13 opposite to the first fixing end 11, and a hollow receiving space 15 formed within the first shaft housing 10. The first fixing end 11 fixes the robot 100 to a support base or the ground (not shown). A substantially cylindrical mounting portion 131 is formed on the second fixing end 13 and defines a through hole (not labeled) coaxial with an axis L of the first shaft housing 10. The receiving space 15 receives the driver 70.

The second shaft housing 30 is substantially hollow shaped and is rotatably connected to the second fixing end 13 of the first shaft housing 10 by means of the transmission mechanism 80. The second shaft housing 30 includes a connecting body 33 and a connecting end 31 coaxially formed on one end of the connecting body 33. The second shaft housing 30 defines an axial through hole passing through the connecting body 33 and the connecting end 31, that is coaxial with the axis L of the first shaft housing 10.

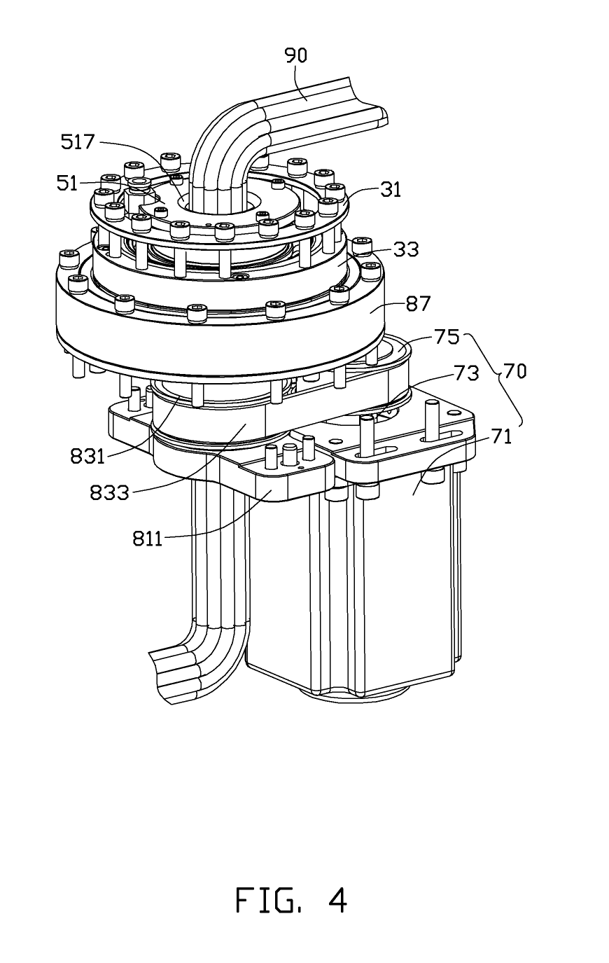

Also referring to FIG. 4, the cable pass-through assembly 50 includes a cable tube 51 and a shaft sleeve 53. In the illustrated embodiment, the cable tube 51 is substantially T-shaped and includes a cylindrical base portion 511 and a fixing portion 513 coaxially perpendicularly disposed at one end of the base portion 511. A cable passage hole 517 is defined coaxially through the base portion 511 and the fixing portion 513. The fixing portion 513 is fixed to the connecting end 31 of the second shaft housing 30. The base portion 511 of the cable tube 51 passes through the axial through hole of the second shaft housing 30 and is partially received within the first shaft housing 10. The shaft sleeve 53 includes a substantially hollow ring shaped main body 531 and a resisting portion 533 extending from a periphery of one end of the main body 531. A conjoint portion of the main body 531 and the resisting portion 533 is substantially arc-shaped. The main body 531 is sleeved on a distal end of the base portion 511 of the cable tube 51 away from the fixing portion 513 and is received within the first shaft housing 10. The resisting portion 533 is positioned away from the second fixing end 13 of the first shaft housing 10.

The driver 70 is assembled within the first shaft housing 10 and connected to the transmission mechanism 80, for driving the transmission mechanism 80 to operate. The driver 70 includes a motor 71, an output shaft 73 and a transmission gear 75. The motor 71 is assembled adjacent to the second fixing end 13 and positioned aside of the distal end of the base portion 511 of the cable tube 51. The output shaft 73 is mounted to the motor 71 and is driven to rotate with the motor 71. An axis of the output shaft 73 is parallel to the axis L. The transmission gear 75 is assembled to a distal end of the output shaft 73 and is received within the first shaft housing 10.

The transmission mechanism 80 includes a support assembly 81, a transmission assembly 83, a speed reduction assembly 85 and a cross roller bearing 87. The support assembly 81 is assembled within the first shaft housing 10 and is positioned adjacent to the second fixing end 13 of the first shaft housing 10, for supporting the cable assembly 50. The support assembly 81 includes a support member 811 and a support bearing 813. The support member 811 is fixed to the second fixing end 13 of the first shaft housing 10 and is rotatably assembled to the shaft sleeve 53 by means of the support bearing 813.

The transmission assembly 83 includes a central gear 831 and a rotating band 833. The central gear 831 is rotatably sleeved on the base portion 511 of the cable tube 51 and is positioned between the support assembly 81 and the second fixing end 13 of the first shaft housing 10. The central gear 831 is coaxial with the cable tube 51 and the axis L of the first shaft housing 10, and is rotatably assembled with the corresponding transmission gear 75 of the driver 70 via the rotating band 833. The rotating band 833 is sleeved on the transmission gear 75 and the central gear 831, thereby gearingly engaging the transmission gear 75 and the central gear 831, such that, the central gear 831 is driven to rotate with the transmission gear 75 via the motor 71.

The speed reduction assembly 85 is sleeved on the base portion 511 of the cable tube 51 and positioned adjacent to the fixing portion 513 end of the cable pass-through assembly 50. The speed reduction assembly 85 includes a speed reducer 851, a first bearing 853 and a second bearing 855. The speed reducer 851 is a harmonic reducer in the illustrated embodiment, and includes a rigid circular spline 8511 and a flexspline 8513 engaging with the rigid circular spline 8511. The flexspline 8513 is sleeved on the base portion 511 of the cable tube 51 and fixed with the central gear 831, such that, the flexspline 8513 is driven to rotate together with the central gear 831 simultaneously via the driver 70. The first bearing 853 is sleeved on the flexspline 8513 and is further connected with the mounting portion 131 of the first shaft housing 10. The second bearing 855 is also sleeved on the flexspline 8513 and is further connected to the connecting body 33 of the second shaft housing 30.

The cross roller bearing 87 includes a bearing cone 871 and a bearing cup 873 engaging with the bearing cone 871. The bearing cone 871 is sleeved on the speed reducer 851 and is fixed with the rigid circular spline 8511 and the connecting body 33 of the second shaft housing 30. The bearing cup 873 is fixed to the second fixing end 13 of the first shaft housing 10, such that, the second shaft housing 30 is driven to rotate together with the bearing cone 871.

The cable assembly 90 passes through the cable passage hole 517 to electrically connect with the driver 70 and other components (not shown) and/or an outside electric power source.

As in use, the output shaft 73 together with the transmission gear 75 is driven to rotate by the motor 71, meanwhile, the central gear 831 is driven to rotate via the rotating band 833, together with the corresponding flexspline 8513. The rigid circular spline 8511 rotatably engages with the flexspline 8513, and drives the bearing cone 871 to rotate. The second shaft housing 30 is then driven to rotate together with the bearing cone 871, such that, the second shaft housing 30 is finally driven to rotate relative to the first shaft housing 10.

Since the first shaft housing 10 and the second shaft housing 30 are both hollow shaped and rotatably assembled together via the transmission mechanism 80. The cable pass-through assembly 50 is fixedly assembled within the second shaft housing 30 and partially received within the first shaft housing 10, which is passing through the transmission mechanism 80; the cable assembly 90 can pass through the cable pass-through assembly 50 to electrically connect with the driver 70 directly assembled within the first shaft housing 10. When the second shaft housing 30 is driven to rotate relative to the shaft housing 10, the cable assembly 90 is received within the cable pass-through assembly 50, and will not wind around the first shaft housing 10 and the second shaft housing 30, whereby damage is avoided, the lifespan of the cable assembly 90 is extended, and the stability of the robot 100 is enhanced.

It is to be understood that, the rotating band 833 can also be omitted, such that, the transmission gear 75 directly meshes with the corresponding central gear 831. The cross roller bearing 87 can also be omitted, such that, the connecting body 33 of the second shaft housing 30 is fixed to the rigid circular spline 8511 of the speed reducer 851 directly.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A robot, comprising:
a first shaft housing, the first shaft housing is hollow shaped;
a driver assembled within the first shaft housing;
a second shaft housing, the second shaft housing is hollow shaped and rotatably assembled to the first shaft housing;
a cable pass-through assembly assembled within the second shaft housing and partially received within the first shaft housing, the cable pass-through assembly defining a cable passage hole coaxially with the second shaft housing;
a cable assembly passing through the cable passage hole and electrically connecting with the driver; and
a transmission mechanism sleeved on the cable pass-through assembly and connecting with the driver and the second shaft housing, the transmission mechanism configured for transmitting the driving force generated by the driver to the second shaft housing, thereby driving the second shaft housing to rotate relative to the first shaft housing.

2. The robot of claim 1, wherein the cable pass-through assembly comprises a cable tube having a base portion and a fixing portion coaxially disposed at one end of the base portion, the cable passage hole is defined through the base portion and the fixing portion coaxially; the fixing portion is fixed to the second shaft housing, the base portion of the cable tube passes through the second shaft housing and is partially received within the first shaft housing.

3. The robot of claim 2, wherein the cable pass-through assembly further comprises a shaft sleeve sleeved on a distal end of the base portion away from the second shaft housing, the driver is positioned aside of the shaft sleeve of the cable pass-through assembly.

4. The robot of claim 3, wherein the shaft sleeve comprises a substantially hollow ring shaped main body and a resisting portion extending from a periphery of one end of the main body, the resisting portion is positioned away from the second shaft housing and forms an arc-shaped conjoint portion between the main body and the resisting portion and being coaxial with the second shaft housing.

5. The robot of claim 3, wherein the transmission mechanism comprises a support assembly and a transmission assembly, the support assembly is fixedly assembled within the first shaft housing and sleeved on the base portion of the cable tube for supporting the cable assembly; the transmission assembly is sleeved on the base portion of the cable tube and positioned adjacent to the shaft sleeve, and connects with the driver and the second shaft housing.

6. The robot of claim 5, wherein, the driver comprises a motor, an output shaft mounted to the motor and a transmission gear assembled to a distal end of the output shaft; the transmission assembly comprises a central gear rotatably sleeved on the base portion of the cable tube and rotatably assembled with the corresponding transmission gear of the driver.

7. The robot of claim 6, wherein the axis of the central gear is coaxial with that of the cable tube and parallel to the output shaft, the transmission assembly further comprises a rotating band, and the central gear is rotatably assembled with the corresponding transmission gear of the driver via the rotating band.

8. The robot of claim 6, wherein the transmission mechanism further comprises a speed reduction assembly sleeved on the base portion of the cable tube and positioned between the transmission assembly and the fixing portion; the speed reduction assembly comprises a speed reducer having a rigid circular spline and a flexspline engaging with the rigid circular spline, the flexspline is sleeved on the base portion of the cable tube and fixed with the central gear, the rigid circular spline is fixed to the second shaft housing.

9. The robot of claim 8, wherein the transmission mechanism further comprises a cross roller bearing having a bearing cone and a bearing cup engaging with the bearing cone, the bearing cone is sleeved on the speed reducer and fixed with the rigid circular spline and the second shaft housing, the bearing cup is fixed to the first shaft housing, such that, the second shaft housing is capable of being driven to rotate together with the bearing cone.

10. A robot, comprising:
a first shaft housing having a fixing end and a hollow receiving space defined within the first shaft housing;
a second shaft housing rotatably assembled to the fixing end of the first shaft housing and defining an axial through hole communicating with the receiving space of the first shaft housing;
a cable pass-through assembly fixedly passing through the second shaft housing and partially inserted into the receiving space of the first shaft housing, the cable pass-through assembly defining a cable passage hole coaxially with the second shaft housing;
a driver assembled within the receiving space of the first shaft housing and positioned adjacent to a distal end of the cable pass-thorough assembly;
a cable assembly passing through the cable passage hole and electrically connecting with the driver;
a transmission mechanism sleeved on the cable pass-through assembly and connecting with the driver and the second shaft housing for transmitting a driving force generated by the driver to the second shaft housing, thereby driving the second shaft housing to rotate relative to the first shaft housing.

11. The robot of claim 10, wherein the transmission mechanism comprises a central gear rotatably sleeved on the cable pass-through assembly and further assembled with the second shaft housing; the driver comprises a motor and a transmission gear assembled to and driven by the motor; the motor is fixed to the fixing end and received within the first shaft housing and positioned adjacent to the central gear; the transmission gear is rotatably assembled with the central gear and is capable of being driven to rotate.

12. The robot of claim 11, wherein the cable pass-through assembly includes a cable tube having a base portion and a fixing portion disposed at one end of the base portion, the cable passage hole is defined through the base portion and the fixing portion coaxially; the fixing portion is fixed to the second shaft housing, the base portion of the cable tube passes through the second shaft housing and is partially received within the first shaft housing; the transmission mechanism further comprises a speed reduction assembly sleeved on the base portion and connecting with the central gear and the fixing portion of the cable pass-through assembly.

13. The robot of claim 12, wherein, the speed reduction assembly comprises a speed reducer having a rigid circular spline and a flexspline engaging with the rigid circular spline, the flexspline is sleeved on the base portion of the cable tube and fixed with the central gear, and the rigid circular spline is fixed to the second shaft housing.

14. The robot of claim 13, wherein, the speed reducer is a harmonic reducer.

15. The robot of claim 13, wherein, the speed reduction assembly further comprises a first bearing and a second bearing, the first bearing is sleeved on the flexspline and further connected with the first shaft housing, the second bearing is sleeved on the flexspline and further connected with the second shaft housing.

16. The robot of claim 13, wherein the cable pass-through assembly further comprises a shaft sleeve sleeved on a distal end of the base portion away from the second shaft housing, the driver is positioned aside of the shaft sleeve of the cable pass-through assembly.

17. The robot of claim 16, wherein the shaft sleeve comprises a substantially hollow ring shaped main body and a resisting portion extending from a periphery of one end of the main body, the resisting portion is positioned away from the second shaft housing and forms an arc-shaped conjoint portion between the main body and the resisting portion and being coaxial with the second shaft housing.
